(19) United States
(12) Patent Application Publication
(10) Pub. No.: US 2022/0169336 A1
(43) Pub. Date: Jun. 2, 2022

(54) MULTI-SPROCKET FOR BICYCLES

(71) Applicant: SRAM DEUTSCHLAND GmbH, Schweinfurt (DE)

(72) Inventors: PETER GEIST, BERLIN (DE); DAVID BOUGHTON, Wurzburg (DE)

(73) Assignee: SRAM DEUTSCHLAND GmbH, Schweinfurt (DE)

(21) Appl. No.: 17/537,649

(22) Filed: Nov. 30, 2021

(30) Foreign Application Priority Data
Dec. 1, 2020 (DE) 102020131862.6

(51) Int. Cl. B62M 9/10; F16F 15/10

(52) U.S. Cl. CPC B62M 9/10; B60B 27/04; F16F 15/10

(57) ABSTRACT

A multi-sprocket assembly for attachment to a rear axle assembly of a bicycle comprises at least one first sprocket, at least one second sprocket, and at least one damping member. The at least one first sprocket has a toothed ring, a coupling opening and a connecting portion connecting the toothed ring to the coupling opening. The at least one damping member extends from the at least one first sprocket toward the at least one second sprocket. The at least one damping member is disposed at least on an axial side surface of the connecting portion of the at least one first sprocket.

This application claims priority to, and/or the benefit of, German patent application DE 10 2020 131 862.6 filed Dec. 1, 2020, the contents of which are incorporated herein in their entirety.

### FIELD OF THE INVENTION

The present disclosure relates to a multi-sprocket assembly for bicycles. Such a multi-sprocket assembly may be attached to a rear axle assembly of a bicycle.

### BACKGROUND

A bicycle may be equipped with a drive assembly such as, for example, a chain drive. Bicycle drive assemblies may serve for transmitting the torque from a cyclist to a rear wheel of the bicycle for the bicycle to be driven. For example, a drive assembly may transmit the torque from a front chain wheel assembly to a rear chain wheel by way of a chain for a rear wheel to be driven. Such a drive assembly may be referred to as a drivetrain.

Chain wheel assemblies for bicycles may have one chain wheel or a plurality of individual chain wheels. The front chain wheels are generally referred to as chain rings. Chainrings may be fastened with the aid of various types of fastening devices. For example, a chainring may be attached with chainring bolts or mounted directly on the crank of a bicycle. The rear chain wheels are often referred to as sprockets. A multiplicity of rear chain wheels or sprockets may be referred to as a multi-sprocket assembly, a sprocket assembly, a cassette, a sprocket cassette, or a sprocket set. Such a multi-sprocket assembly or cassette typically is configured such that the multi-sprocket assembly or cassette may be fastened to a freewheel body of a rear wheel. The drive assembly may furthermore comprise a rear derailleur for shifting the chain between the individual sprockets of the multi-sprocket assembly. The rear derailleur may thus be used to engage different gear ratios or gears, with the respective gear ratio depending on which sprocket of the multi-sprocket assembly the chain is located on. For example, multi-sprocket assemblies are known from U.S. Pat. No. 10,112,681 B2 or EP 2 319 752 A2.

### SUMMARY

A multi-sprocket assembly for attachment to a rear axle assembly of a bicycle comprises at least one first sprocket, at least one second sprocket, and at least one damping member. The at least one first sprocket has a toothed ring, a coupling opening and a connecting portion connecting the toothed ring to the coupling opening. The at least one damping member extends from the at least one first sprocket toward the at least one second sprocket. The at least one damping member is disposed at least on an axial side surface of the connecting portion of the first sprocket.

A rear wheel assembly for a bicycle comprises a rear wheel having a rear wheel axle configured to be coupled to a bicycle frame, a driver body rotatably supported on the rear wheel axle, and a multi-sprocket assembly attached to the driver body in a drive direction. The multi-sprocket assembly comprises at least one first sprocket, at least one second sprocket, and at least one damping member. The at least one first sprocket has a toothed ring, a coupling opening and a connecting portion connecting the toothed ring to the coupling opening. The at least one damping member extends from the at least one first sprocket toward the at least one second sprocket. The at least one damping member is disposed at least on an axial side surface of the connecting portion of the at least one first sprocket.

### BRIEF DESCRIPTION OF THE DRAWINGS

Exemplary embodiments will be described hereunder with reference to the appended figures, in which:

FIG. 1 shows a schematic view of a bicycle;

FIG. 2 shows a plan view of a multi-sprocket assembly according to one embodiment;

FIG. 3 shows a sectional view along the section line III-III in FIG. 2;

FIG. 4 shows a sectional view along the section line IV-IV in FIG. 3;

FIG. 5 shows a partially cutaway perspective view of the sprocket assembly according to FIGS. 2 to 4;

FIG. 6 shows a view of an enlarged fragment from FIG. 5;

FIG. 7 shows a sectional view of a multi-sprocket assembly according to a further embodiment; and

FIG. 8 shows a partially cutaway perspective view of the multi-sprocket assembly according to FIG. 7.

### DETAILED DESCRIPTION

It is an object of the present disclosure to provide a multi-sprocket assembly by way of which the noises arising in the operation of the multi-sprocket assembly may be reduced.

The multi-sprocket assembly for attachment to a rear axle assembly of a bicycle comprises at least one first sprocket, at least one second sprocket, and at least one damping member. The at least one damping member extends from the at least one first sprocket toward the at least one second sprocket. The at least one damping member is disposed at least on an axial side surface of the first sprocket.

The at least one damping member serves to improve the acoustics of the multi-sprocket assembly. The at least one damping member improves the acoustics by allowing the vibrations and/or sound to be dampened by the at least one damping member. The at least one damping member is in contact with at least an axial side surface of a sprocket of the multi-sprocket assembly for damping vibrations or sound.

The at least one damping member may be supported on at least the axial side surface of the first sprocket. The at least one damping member may be attached to at least the axial side surface of the first sprocket.

The at least one damping member may contact the at least one second sprocket at least in the radial direction. The at least one damping member in the radial direction may be supported at least on one further sprocket of the multi-sprocket assembly, wherein the at least one further sprocket may be a sprocket which is adjacent to the first sprocket or a sprocket which in the axial direction is more remote from the first sprocket. The at least one damping member may at least partially contact a radially inner periphery or a radially inner face of the corresponding sprocket. The radial contact between the at least one damping member and the at least one second sprocket may contribute toward centering the at least one damping member during assembling.

The at least one damping member in the axial direction may be supported at least on the mutually facing axial side surfaces of the first sprocket and of the second sprocket. The at least one damping member, apart from being supported on the first sprocket and the second sprocket, may also be supported on a further sprocket and/or a sprocket module of the multi-sprocket assembly. It is also conceivable that the at least one damping member is supported on a further component, such as for example a closure member, of the multi-sprocket assembly. The at least one damping member, in particular in the axial direction, may be supported at least on the axial side surfaces of the first sprocket and of the second sprocket. The at least one damping member may have axial side surfaces and/or axial end surfaces by way of which the damping member may be supported on the axial side surfaces of the sprockets.

The first sprocket and the second sprocket may be sprockets which in the axial direction are disposed in a central region of the multi-sprocket assembly. The at least one first sprocket may have a diameter which is smaller than the diameter of the largest sprocket but larger than the diameter of the smallest sprocket. The second sprocket may have a diameter which is larger or smaller than the diameter of the first sprocket.

At least the at least one first sprocket of the multi-sprocket assembly may be configured for coupling the multi-sprocket assembly in a torque-transmitting manner to the rear axle of the bicycle. The multi-sprocket assembly may be supported on the rear axle of the bicycle at least by the at least one first sprocket. The at least one first sprocket may be able to be coupled in a torque-transmitting manner to a driver body on the rear axle of the bicycle, for example, and be supported on this driver body. It is however also conceivable that a plurality of sprockets of the multi-sprocket assembly can be coupled in a torque-transmitting manner to the rear axle of the bicycle, and in particular to a driver body.

The at least one first sprocket may form an end sprocket of the multi-sprocket assembly. In this case, the at least one first sprocket may be the largest sprocket, i.e., the sprocket with the largest tooth count and/or the largest diameter. Such an end sprocket may couple the multi-sprocket assembly in a torque-transmitting manner to the rear axle assembly of the bicycle. The multi-sprocket assembly in the radial direction may be supported on the rear axle assembly of the bicycle via the end sprocket.

The at least one damping member may be held between the at least one first sprocket and the at least one second sprocket by a press fit. The at least one damping member may be oversized in the axial direction. The axial extent of the damping member may be greater than the axial distance between the axial side surfaces of the first sprocket and of the second sprocket. During assembly, the at least one damping member is inserted between the first and second sprockets before the first sprocket and the second sprocket are connected to one another, for example by pins or bolts. Accordingly, the damping member is jammed or compressed when the first sprocket and the second sprocket are connected such that the damping member is held between the first sprocket and the second sprocket via a press fit.

The at least one damping member may be oversized in the radial direction. For example, the outer diameter of the at least one damping member may be at least partially larger than the inner diameter of at least one sprocket of the multi-sprocket assembly.

The at least one damping member may be permanently fixedly connected to the first sprocket and/or the second sprocket. In a permanently fixed connection of the damping member to the first sprocket and/or the second sprocket, a contact area between the damping member and at least one of the first sprocket or the second sprocket may be enlarged such that the damping effect of the at least one damping member may be further amplified.

The at least one damping member may be adhesively bonded or glued to the first sprocket and/or the second sprocket. The at least one damping member may be adhesively bonded to an axial side surface of the first sprocket, for example, and extend from this axial side surface towards an axial side surface of the second sprocket. In this case, the at least one damping member may be attached to only the axial side surface of the at least one first sprocket. It is also conceivable that the damping member contacts only the axial side surface of the first sprocket. Furthermore, the at least one damping member may be adhesively bonded to the axial side surfaces of the first sprocket and the second sprocket. For example, the at least one damping member may be adhesively bonded to an axial side surface of the first sprocket and extend from the axial side surface toward a radially inner edge or a radially inner surface of the second sprocket. The at least one damping member may at least partially bear against this radially inner edge or this radially inner surface. The at least one damping member may, for example, bear with its radially outer surface against the radially inner edge or the radially inner surface of the second sprocket.

The at least one first sprocket may have a toothed ring, a coupling opening and a connecting portion which connects the toothed ring to the coupling opening. The coupling opening may be configured for coupling the multi-sprocket assembly in a torque-transmitting manner to a rear wheel axle of the bicycle. To this end, the coupling opening may have a torque-transmitting contour which may be coupled to a complementary contour on the rear axle assembly, or a driver body of the rear axle assembly. The toothed ring extends radially outwardly about the coupling opening and is connected to the coupling opening via the connecting portion. The connecting portion between the toothed ring and the coupling opening may be formed by a sprocket arm or a plurality of sprocket arms.

The at least one damping body may be disposed on the toothed ring of the first sprocket. In this case, the at least one damping member may be disposed on a radially outer region (but radially inward of the teeth of the sprocket) of the first sprocket. The second sprocket may be the next smallest sprocket, for example. The at least one damping member may be disposed between the first sprocket and the second sprocket, the latter being formed by the next smallest sprocket.

The at least one damping member may be disposed on the connecting portion of the first sprocket. The connecting portion in radial terms may be situated within the toothed ring. The at least one damping member in the radial direction may be disposed between the toothed ring and the coupling opening of the first sprocket. The at least one damping member may be disposed in a central region of the radial extent of the first sprocket. The at least one damping member may extend from the connecting portion of the first sprocket towards the second sprocket which is in an axial direction in a central region of the multi-sprocket assembly or represents one of the medium-sized sprockets of the multi-sprocket assembly. The at least one contact area between the damping member and the first sprocket and/or the damping member and the second sprocket may be increased such that the damping effect of the at least one damping member may be further enhanced. Moreover, contaminations may be pushed out by the chain in a radially inward direction of the multi-sprocket assembly, whereby shifting errors due to foreign matter may be avoided. The damping member disposed further inward in the radial direction may be protected in relation to external mechanical stresses such as, for example, caused by a high-pressure washer or caused by foreign matter/dirt.

The at least one damping member may extend in the axial direction along at least one further sprocket to the second sprocket. The at least one damping member may extend from the first sprocket radially within the at least one further sprocket to the second sprocket. The at least one damping member may be configured such that the damping member does not contact the at least one further sprocket.

The at least one damping member may be configured to have an annular shape. The at least one damping member may have axial side surfaces and/or axial end faces. The at least one damping member may have a predetermined axial extent.

The at least one damping member may have at least one radially outer surface and at least one radially inner surface. The radially inner surface and/or the radially outer surface of the at least one damping member in the radial direction may be in contact at least with the at least one second sprocket or a further component of the multi-sprocket assembly. There may be continuous radial contact, or sectional radial contact, between the radially inner face and/or the radially outer face of the at least one damping member and the at least one second sprocket or a further component of the multi-sprocket assembly.

It is furthermore conceivable that the at least one radially outer surface and the at least one radially inner surface are not in contact, or are in contact only in certain portions, with the multi-sprocket assembly or a sprocket. In this case, there may be continuous or planar contact only between the at least one damping member and at least one axial side surface of the first sprocket and/or of the second sprocket.

The at least one damping member may have at least one recess on at least one radially outer surface or a radially outer edge and/or on at least one radially inner surface or a radially inner edge. The at least one recess may be provided, for example, for the pins for connecting two adjacent sprockets. The at least one damping member may bear against the pins in the region of the recesses. Furthermore, the at least one recess may be provided on the radially inner surface of the at least one damping member for one of the sprocket arms.

The at least one damping member may be produced from an elastic plastics material or an elastic plastic foam. The at least one damping member may, for example, be made of a polyurethane foam. For example, the damping member may be made of a plastic foam sold under the name Cellasto®. The damping member may also be made of a plastics material sold under the name Sylomer®. The plastics foam may be of closed-cell design to minimize the absorption of moisture and dirt.

The multi-sprocket assembly may be composed of a plurality of individual sprockets which are connected to one another by pins or bolts. The multi-sprocket assembly may also have sprocket assemblies or modules of sprockets which are formed in a one-piece construction with one another or welded to one another. For example, the smallest sprocket of a multi-sprocket assembly may form such a sprocket module. These sprocket modules may be connected to individual sprockets or a further sprocket module by bolts or pins. Furthermore, only the end sprocket of the multi-sprocket assembly may be embodied as an individual sprocket, and the remaining sprockets of the multi-sprocket assembly may form a sprocket module of the type described above.

The present disclosure furthermore relates to a rear wheel assembly for a bicycle. The rear wheel assembly comprises a rear wheel having a rear wheel axle which is configured for attachment to a bicycle frame, a driver body rotatably mounted on the rear wheel axle, and a multi-sprocket assembly of the type described above which may be coupled to the driver body in a drive direction.

The driver body may be coupled to the rear wheel axle via a freewheel device. The driver body may also be referred to as a “freewheel body”.

The spokes and/or the composite surfaces of the rear wheel may contribute towards the generation of vibrations and/or sound emissions which may lead to undesirable noises when riding a bicycle. The air pressure of the rear wheel tires may also play a part in the generation of these undesirable noises. With the at least one damping member or with the aforementioned rear wheel arrangement, such vibrations and/or sound radiations may be dampened and thus the undesirable noises may be prevented.

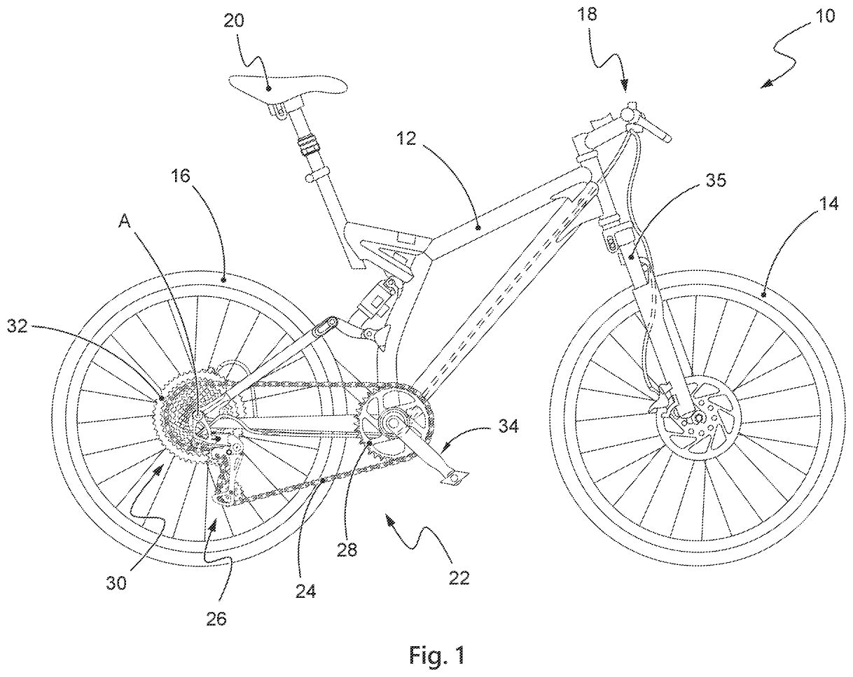

FIG. 1 shows an exemplary bicycle 10. The bicycle 10 comprises a bicycle frame 12, a front wheel 14, a rear wheel 16, a handlebar 18, a saddle 20 and a drive assembly 22. The drive assembly 22 comprises a chain 24, a derailleur 26, a front chain wheel 28 and a rear multi-sprocket assembly 30 having a plurality of sprockets 32. Each sprocket 32 has a plurality of teeth on its outer periphery engageable with the chain 24. The front chain wheel 28 is connected to a crank assembly 34. Pedals are provided on the crank assembly 34.

The directional indications right/left, and front/rear used hereunder refer to a bicycle 10 in the travel direction, thus corresponding to the cyclist's perspective on the bicycle 10.

The front wheel 14 is coupled to the bicycle frame 12 by a front fork 35. The front fork 35 is connected to the handlebar 18. The bicycle frame 12 typically has a left and a right dropout or frame eye, between which the rear wheel 16 is mounted. The rear wheel 16 rotates together with the multi-sprocket assembly 30 about the rotation axis A. The term “axial” here refers to the rotation axis A of the multi-sprocket assembly 30 or to a direction which is parallel to the rotation axis A and in FIG. 1 runs so as to be perpendicular to the drawing plane. The diameter of the sprockets 32 decreases outwardly in the axial direction of the axis A, i.e., the largest sprocket is axially further inward than the smaller sprockets. The explanations above refer to a bicycle having a known sprocket assembly as well as a sprocket assembly according to the disclosure.

The multi-sprocket assembly 30 is coupled in a torque-transmitting manner to a driver body (not shown) of the axle assembly on the rear wheel 16 of the bicycle 10 and is fastened to this driver body. A torque may be transmitted to the axle assembly on the rear wheel 16 and thus to the rear wheel 16 of the bicycle 10 via of the multi-sprocket assembly 30. The derailleur 26 may move the chain 24 between the individual sprockets 32 of the multi-sprocket assembly 30, that is, the chain 24 may be moved from one sprocket 32 to the next by the rear derailleur 26. Different gear ratios or gears may thus be engaged by the derailleur 26, wherein the respective gear ratio depends on which sprocket 32 of the multi-sprocket assembly 30 the chain 24 is located at.

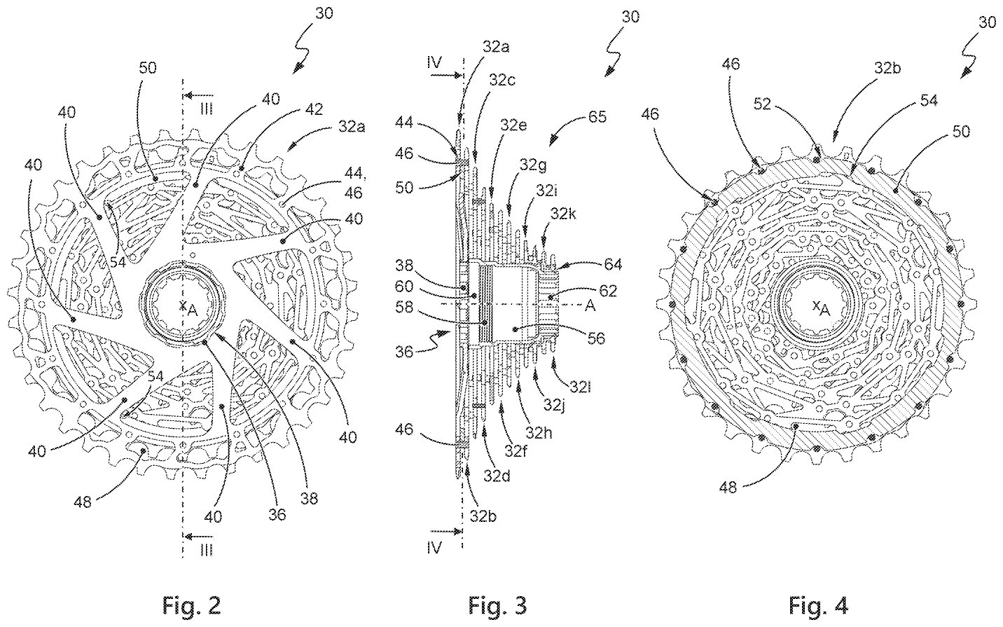

FIGS. 2, 3 and 4 show various views of a multi-sprocket assembly 30 according to a first embodiment, wherein FIG. 3 shows a sectional view along the section line III-III in FIG. 2, and FIG. 4 shows a sectional view along the section line IV-IV in FIG. 3. The multi-sprocket assembly 30 has an end sprocket 32a. The end sprocket 32a serves for transmitting torque from the multi-sprocket assembly 30 to the axle assembly on the rear wheel 16 (see FIG. 1). The multi-sprocket assembly 30 may be supported on the rear wheel axle by way of the end sprocket 32a. The end sprocket 32a represents the sprocket with the largest diameter of the multi-sprocket assembly 30. The end sprocket 32a is adjoined by a plurality of further sprockets 32b to 32l (see FIG. 3). The diameter of the sprockets 32b to 32l decreases from the end sprocket 32a in the axial direction outwards.

The end sprocket 32a has a coupling opening 36 by way of which the multi-sprocket assembly 30 may be mounted on an axle assembly on the rear wheel 16. The coupling opening 36 has a torque-transmitting contour on its the inner circumference by which the multi-sprocket assembly 30 may be coupled in a torque-transmitting manner to a driver body (not shown) of the axle assembly on the rear wheel 16. The torque-transmitting contour comprises a plurality of projections 38 extending inwardly in the radial direction. The driver body of the axle assembly on the rear wheel 16 has a contour on its outer surface that is complementary to the torque-transmitting contour formed at the coupling opening 36 of the end sprocket 32a. The end sprocket 32a furthermore has sprocket arms 40 which extend between the coupling opening 36 and a toothed ring 42 having the sprocket teeth on its outer periphery. The sprocket arms 40 connect the coupling opening 36 to the radially outer toothed ring 42, that is, the sprocket arms 40 are configured in a connecting portion between the toothed ring 42 and the coupling opening 36.

Openings 44 are configured in the toothed ring 42, into which pins or bolts 46 are inserted for connecting to the next smallest sprocket 32b. The toothed ring 42 furthermore has a plurality of openings 48. Among other things, the openings 48 contribute to the weight savings of the multi-sprocket assembly 30. As may be seen in FIGS. 2 and 4, a plurality of the sprockets 32b to 32l have identical or similar openings 48. The openings 48 are configured between the openings 44 for the bolts 46.

The multi-sprocket assembly 30 has a damping member 50. The damping member 50 serves for damping vibrations and sound. The acoustics of the multi-sprocket assembly 30 may be improved by the damping member 50, that is to say that undesirable noises which arise in the operation of the multi-sprocket assembly 30 may be reduced. The damping member 50 is disposed between the end sprocket 32a and the next smallest sprocket 32b. The damping member 50 bears on an axial side surface of the end sprocket 32a and on an axial side surface of the next smallest sprocket 32b. The axial side surface of the next smallest sprocket 32b faces the end sprocket 32a. The damping member 50 projects radially inwardly beyond the toothed ring 42 of the end sprocket 32a.

The shape of the damping member 50 may be seen in particular in FIG. 4 in which the damping member 50 is illustrated in a sectional view along the section line IV-IV according to FIG. 3. The damping member 50 is configured to be substantially annular. The damping member 50 extends along the sprocket 32b. The radial extent of the damping member 50 is smaller than the radial extent of the annular sprocket 32b. The damping member 50 bears against the sprocket 32b.

The damping member 50 has recesses 52 in which the bolts 46 for connecting the end sprocket 32a and the sprocket 32b extend. The recesses 52 are configured on the radially outer periphery of the damping member 50. The damping member 50 furthermore has further recesses 54. The recesses 54 are provided on the radially inner periphery of the damping member 50. The recesses 54 are configured at positions on the damping member 50 where the sprocket arms 40, extend from the toothed ring 42 in the direction of the coupling opening 36. According to this embodiment, six recesses 54 are provided as the end sprocket 32a has six sprocket arms 40.

The damping member 50 may be attached to the multi-sprocket assembly 30 via a press-fit or interference fit. During assembly of the multi-sprocket assembly 30, the damping member 50 may be inserted and compressed between the end sprocket 32a and the next smallest sprocket 32b. In this manner, the damping member 50 is secured to the multi-sprocket assembly 30 via a press fit. Prior to attachment or assembly, the damping member 50 has a greater axial extent than the axial distance between the end sprocket 32a and the next smallest sprocket 32b. The damping member 50 in the initial state, before being compressed during assembly, is thus axially oversized.

The multi-sprocket assembly 30 furthermore comprises a lock member, or a lock tube 56. The lock tube 56 serves for connecting the multi-sprocket assembly 30 to a driver body (not shown) which is rotatably mounted on the rear wheel axle A. The lock tube 56 has an internal thread 58. The multi-sprocket assembly 30 may be screwed to the driver body via the internal thread 58. The lock tube 56 furthermore has a portion 60 which contacts the end sprocket 32a. In the state in which the lock tube 56 is screwed to a driver body, the portion 60 holds the end sprocket 32a, and thus the entire multi-sprocket assembly 30, in its predetermined position on the driver body in the axial direction. In this predetermined position, the torque-transmitting contour on the coupling opening 36 of the end sprocket 32a engages in a torque-transmitting manner with a complementary contour on the driver body. The lock tube 56 furthermore has support projections 62 which extend in the axial direction. The support projections 62 support the multi-sprocket assembly 30 in the radial direction. To this end, the support projections 62 may contact the sprockets 32k and 32l. The support protrusions 62 extend radially within the two sprockets 32k and 32l. The two sprockets 32k and 32l represent the “smallest” sprockets of the multi-sprocket assembly 30, that is to say that the sprockets 32k and 32l have the smallest tooth count of the multi-sprocket assembly, wherein the sprocket 32l has the fewest teeth. In the area of the support projections, a groove is provided on the outer circumference of the lock tube 56 in which a retaining ring 64 is disposed for axially fixing the sprocket cluster 65 on the lock tube 56. The retaining ring 64 engages behind the smallest sprocket 32l.

The sprockets 32b to 32h, like the end sprocket 32a, are individual sprockets. The end sprocket 32a and the sprockets 32b to 32h are connected to one another by the bolts 46, as may be seen in particular in FIG. 3. The sprockets 32j, 32k and 32l may be integrally configured or be welded to one another. The sprockets 32j, 32k and 32l thus form a sprocket module which is connected to the adjacent sprocket 32i by the bolts 46.

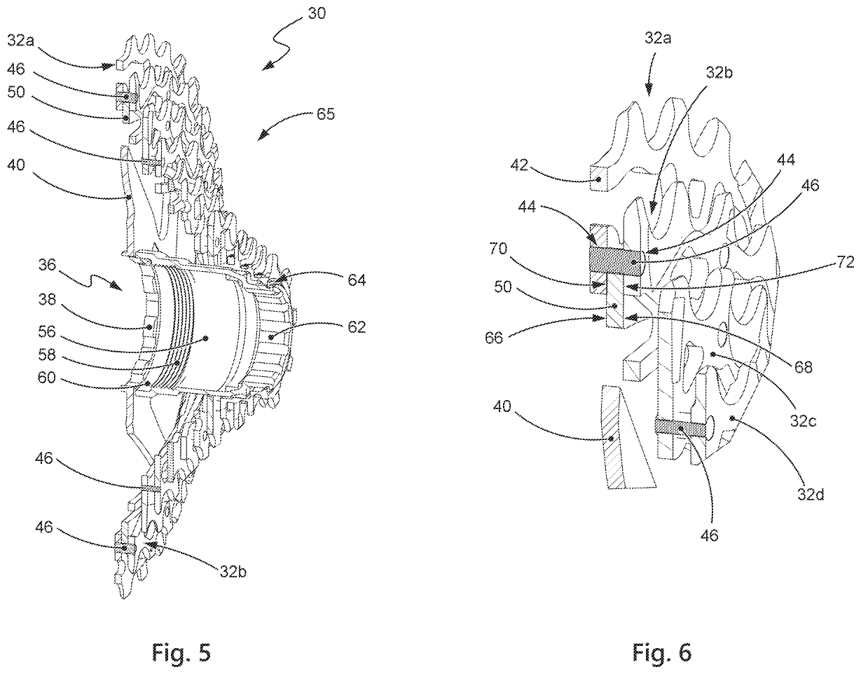

FIG. 5 shows a perspective view of the multi-sprocket assembly 30. The damping member 50 is disposed between the end sprocket 32a and the next smallest sprocket 32b. The damping member 50 is held between the end sprocket 32a and the sprocket 32b by a press fit. The end sprocket 32a and the sprocket 32b represent individual sprockets which are connected to one another by the bolts 46. The damping member 50 bears with its radially outer periphery or radially outer surface against the bolts 46.

FIG. 6 shows an enlarged section from FIG. 5. In particular, FIG. 6 shows the end sprocket 32a and the next smallest sprocket 32b which are connected by the bolts 46. Both sprockets 32a and 32b have respective openings 44 through which a bolt 46 extends to connect the two sprockets 32a, 32b. The damping member 50 extends radially inwardly from the region in which the bolts 46 are arranged. The damping member 50 by way of the axial side surfaces 66, 68 bears at least in portions on the axial side surface 70 of the first sprocket 32a and at least in portions on the axial side surface 72 of the second sprocket 32b. The axial side surfaces 70, 72 of the sprockets 32a, 32b face one another. The press-fit for fastening the damping member 50 is thus established by way of the axial side surfaces 70, 72 of the sprockets 32a, 32b. The damping member 50 at least partially fills the intermediate space between the two sprockets 32a and 32b.

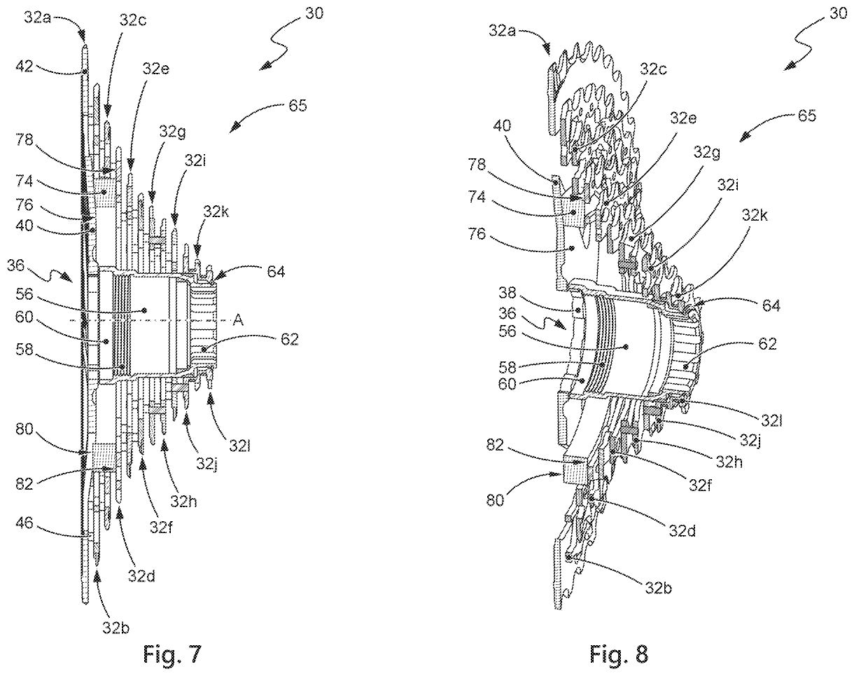

FIG. 7 shows a sectional view of a multi-sprocket assembly 30 according to a second embodiment. FIG. 8 shows a partially cutaway perspective view of the multi-sprocket assembly 30 according to the second embodiment.

The basic structure of the multi-sprocket assembly 30 according to the second embodiment corresponds to the basic structure of the multi-sprocket assembly 30 according to the first embodiment, the latter having been described with reference to FIGS. 2 to 6. The preceding explanations relating to the first embodiment thus apply in an analogous manner also to the multi-sprocket assembly 30 according to the second embodiment.

The multi-sprocket assembly 30 has a damping member 74. The damping member 74 is disposed between the end sprocket 32a and the third largest sprocket 32d of the multi-sprocket assembly 30, which here forms the second sprocket of the damping structure comprising the end sprocket 32a, the damping member 74 and the sprocket 32d. The sprocket 32d is one of the medium-sized sprockets of the multi-sprocket assembly 30, that is to say that the sprocket 32d in the axial direction is disposed approximately in a central region of the multi-sprocket assembly 30. By virtue of the damping member 74 extending approximately into a central region of the multi-sprocket assembly 30, or the sprocket cluster 65, respectively, acoustic vibrations of the self-supporting sprocket cluster 65, assembled here from the sprockets 32b to 32j by the bolts 46, may be particularly effectively dampened. This applies in an analogous manner also to the sprocket cluster 65 (not illustrated in the figures), the latter being integral, for example, or assembled by welding a plurality of individual sprocket rings.

The damping member 74 extends between the mutually facing axial side surfaces 76, 78 of the end sprocket 32a and the sprocket 32d. As opposed to the first embodiment, the damping member 74 is not disposed between the end sprocket 32a and the next smallest sprocket 32b but between the end sprocket 32a and the sprocket 32d, the latter having a smaller diameter than the sprocket 32b.

The damping member 74 is disposed to be radially within the toothed ring 42 of the end sprocket 32a. The damping member 74 is disposed on the sprocket arms 40, i.e., at the connection area defined by the sprocket arms 40 between the toothed ring 42 and the coupling opening 36 of the end sprocket 32a. The damping member 74 is supported on the sprocket arms 40. The damping member 74 extends from the axial side surface 76 of the sprocket 32a in the direction of the sprocket 32d. The damping member 74 is also supported on the axial side surface 78 of the sprocket 32d. The damping member 74 is held between the end sprocket 32a and the sprocket 32d by a press fit. The damping member 74 contacts only the axial side surface 76 of the first sprocket 32a and the axial side surface 78 of the sprocket 32d of the multi-sprocket assembly 30.

The damping member 74 extends from the end sprocket 32a radially inward of the sprocket 32b, i.e., the next smallest sprocket 32b after the end sprocket 32a, and the sprocket 32c to the second sprocket 32d. The damping member 74 does not contact the sprockets 32b and 32c.

The damping member 74 is annular in shape. The damping member 74 has a predetermined axial extent. The damping member 74 has two end faces 80 and 82. With the end face 80, the damping member 74 bears on the axial side surface 76 of the end sprocket 32a in the region of the sprocket arms 40. With the end face 82, the damping member 74 rests against the sprocket 32d. The damping member 74 in the radial direction projects beyond the inner circumference of the sprocket 32d.

The damping member 50, 72 serves to improve the acoustics of the multi-sprocket assembly 30, as vibrations and/or sound may be dampened by the damping member 50, 74.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A multi-sprocket assembly for attachment to a rear axle assembly of a bicycle, comprising:
at least one first sprocket having a toothed ring, a coupling opening and a connecting portion connecting the toothed ring to the coupling opening;
at least one second sprocket; and
at least one damping member, the at least one damping member extending from the at least one first sprocket toward the at least one second sprocket, wherein the at least one damping member is disposed at least on an axial side surface of the connecting portion of the at least one first sprocket.

2. A multi-sprocket assembly according to claim 1, wherein the at least one damping member is supported at least on mutually facing axial side surfaces of the first sprocket and of the second sprocket.

3. A multi-sprocket assembly according to claim 1, wherein the at least one damping member contacts the at least one second sprocket at least in the radial direction.

4. A multi-sprocket assembly according to claim 1, wherein at least the first sprocket is configured for coupling the multi-sprocket assembly in a torque-transmitting manner to the rear axle assembly of the bicycle.

5. A multi-sprocket assembly according to claim 1, wherein the at least one damping member is held between the at least one first sprocket and the at least one second sprocket via a press fit.

6. A multi-sprocket assembly according to claim 1, wherein the at least one damping member is permanently fixedly connected to the first sprocket and/or the second sprocket.

7. A multi-sprocket assembly according to claim 1, wherein the at least one damping member is annular.

8. A multi-sprocket assembly according to claim 1, wherein the at least one damping member has at least one recess on at least one radially outer surface and/or on at least one radially inner surface.

9. A multi-sprocket assembly according to claim 1, wherein the at least one damping member is made of a plastics material or of a plastic foam.

10. A rear wheel assembly for a bicycle, comprising:
a rear wheel having a rear wheel axle configured to be coupled to a bicycle frame;
a driver body rotatably supported on the rear wheel axle; and
a multi-sprocket assembly attached to the driver body in a drive direction, the multi-sprocket assembly comprising:
at least one first sprocket having a toothed ring, a coupling opening and a connecting portion connecting the toothed ring to the coupling opening,
at least one second sprocket, and
at least one damping member, the at least one damping member extending from the at least one first sprocket toward the at least one second sprocket, wherein the at least one damping member is disposed at least on an axial side surface of the connecting portion of the at least one first sprocket.

11. A rear wheel assembly according to claim 10, wherein the at least one damping member is supported at least on mutually facing axial side surfaces of the at least one first sprocket and of the least one second sprocket.

12. A rear wheel assembly according to claim 10, wherein the at least one damping member contacts the at least one second sprocket at least in the radial direction.

13. A rear wheel assembly according to claim 10, wherein at least the first sprocket is configured for coupling the multi-sprocket assembly in a torque-transmitting manner to the rear axle assembly of the bicycle.

14. A rear wheel assembly according to claim 10, wherein the at least one damping member is held between the at least one first sprocket and the at least one second sprocket via a press fit.

15. A rear wheel assembly according to claim 10, wherein the at least one damping member is permanently fixedly connected to the first sprocket and/or the second sprocket.

16. A rear wheel assembly according to claim 10, wherein the at least one damping member is annular.

17. A multi-sprocket assembly according to claim 10, wherein the at least one damping member has at least one recess on at least one radially outer surface and/or on at least one radially inner surface.

18. A multi-sprocket assembly according to claim 10, wherein the at least one damping member is made of a plastics material or of a plastic foam.
